(19) United States
(12) Patent Application Publication
(10) Pub. No.: US 2026/0076302 A1
(43) Pub. Date: Mar. 19, 2026

(54) A Cleaning System for a Sensor Arrangement

(71) Applicant: AGCO International GmbH, Neuhausen (CH)

(72) Inventor: Dan Hermann, Randers (DK)

(21) Appl. No.: 19/108,712

(22) PCT Filed: Sep. 8, 2023
(86) PCT No.: PCT/IB2023/058912

§ 371 Date: Mar. 4, 2025

(30) Foreign Application Priority Data
Sep. 29, 2022 (GB) 2214261.6

(51) Int. Cl. A01D 41/127

(52) U.S. Cl. CPC A01D 41/1276

(57) ABSTRACT

Systems and methods are provided for controlling operation of a cleaning system for a sensor arrangement of an agricultural machine. Operational data for the machine is used to determine the working of a working environment by the agricultural machine, such as whether a given operation is being performed or not at a given time and/or location. Operation of the cleaning system is then controlled in dependence on the determined operation.

### CROSS-REFERENCE TO RELATED APPLICATIONS

Not applicable.

### FIELD

Embodiments of the present disclosure relate generally to control of a cleaning system for a sensor arrangement of an agricultural machine.

### BACKGROUND

It is known to provide sensing arrangements on agricultural machines for monitoring the operation of different agricultural tasks being performed by the machine. In some instances, such sensing arrangements are provided for monitoring material flow through the machine. For example, it is known to provide an optical sensor within or adjacent to a flow of crop material through a harvester, with one example including a grain quality sensor positioned to image grain material within a combine harvester.

Due to the nature of such agricultural operations it has been observed that such sensors quickly become obscured by dust and other non-grain material and hence require periodic cleaning of sensing surfaces of those arrangements to ensure a reliable reading from the sensors. With known systems, the operator must either incur downtime of the machine for cleaning of the sensor arrangements or be left with unreliable data relating to the material. In some instances the sensor surface may not be immediately accessible, and hence such downtimes could be lengthy.

It would be advantageous to provide a control system and method which overcomes or at least partly mitigates the problems discussed herein.

### BRIEF SUMMARY

In an aspect of the invention there is provided a control system for a sensing arrangement of an agricultural machine, the control system comprising one or more controllers, configured to: receive operational data indicative of the working of a working environment by the agricultural machine; and generate and output one or more control signals for controlling operation of a cleaning system associated with a sensor arrangement of the agricultural machine in dependence on the operational data.

Advantageously, the present invention utilises operational data indicative of the working of a working environment by the agricultural machine (e.g. if, where and/or how a given operation if being performed by the agricultural machine) to control the operation of the cleaning system. This may advantageously be used, for example, to control timing of the cleaning operation of the sensor to prevent such an operation obscuring or otherwise preventing the sensing arrangement, which may be utilised for monitoring operation/working of the agricultural machine, from being operable when required. The operational data associated with the machine when within the working environment may be indicative of whether the sensing arrangement may be obscured from the cleaning system, e.g. due to the presence of material (grain or the like) on a surface thereof. Accordingly, it may be advantageous to control the timing of the cleaning system operation based on this operational data to increase the efficiency of the associated cleaning operation.

The one or more controllers may collectively comprise an input (e.g. an electronic input) for receiving one or more input signals. The one or more input signals may comprise the operational data indicative of the working of a working environment by the agricultural machine. The one or more controllers may collectively comprise one or more processors (e.g. electronic processors) operable to execute computer readable instructions for controlling operational of the control system, for example, to determine an operational status of the agricultural machine in dependence on the received operational data. The one or more processors may be operable to generate one or more control signals for controlling operation of the cleaning system. The one or more controllers may collectively comprise an output (e.g. an electronic output) for outputting the one or more control signals.

The operational data may comprise positional data, which may be indicative of a location of the agricultural machine within the working environment. The control system may be configured to determine, from the positional data, the location of the agricultural machine within the working environment.

The operational data may comprise sensor data from one or more sensors on, in or otherwise associated with the agricultural machine. The one or more sensors may include a yield sensor. In such embodiments, the operational data may comprise yield data indicative of a measure of material within and/or flowing through the agricultural machine. This may include a measure of an amount, e.g. volume, flow rate, etc. of grain flowing through an agricultural machine in the form of a harvesting machine, for example. Advantageously, the present invention may utilise yield data to determine if grain or other material is flowing through, and in specific embodiments past the sensing arrangement and control operation of the cleaning system accordingly. For example, the control system may be configured to cause actuation of the cleaning system where the yield data indicates a reduction in flow, or no flow, of material in the region of the sensing arrangement.

The operational data may be indicative of an operational state of a selectable operational function of the agricultural machine. The control system may be configured to control operation of the cleaning system in dependence on the operational state of the selectable operational function, e.g. upon determination of the operational state of the selectable operational function in dependence on analysis of the operational data. The selectable operational function may comprise a headland mode for the agricultural machine. A headland mode may comprise adjusting operation (e.g. through movement of the position, working speed, etc.) of one or more working components of the agricultural machine. Where the agricultural machine comprises a working component which engages with the working environment, e.g. a header for a harvester, a headland mode may comprise the lifting of the header, for example. The operational function may be selectable by an operator of the agricultural machine, e.g. through a user interface provided in (e.g. a user terminal) or otherwise associated with the machine (e.g. a remote computing unit, laptop, smartphone etc.). The operational function may be selectable automatically in dependence on an operational state and/or position of the agricultural machine. For instance, the machine may automatically enter a headland mode upon determination of the machine being located within or entering a headland of the working environment, e.g. as determined through use of a positioning module of the machine.

The control system may be configured to determine, from the operational data, whether the agricultural machine is located within a working region or a non-working region of the working environment. For instance, the control system may be configured to determine, from positional data, the location of the agricultural machine with respect to a working region and/or a non-working region of the working environment. The non-working region of the working environment may comprise a headland region of the working environment, for example. The working region may comprise a crop region or the like, and may include a region within the working environment wherein an implement or other component of or associated with the agricultural machine works the environment, e.g. harvesting, raking, tedding, cultivating, etc.

The control system may be configured to cause performance of a cleaning operation by the cleaning system in dependence on a determination of the agricultural machine being positioned within a non-working region of the working environment. The control system may be configured to cause performance of a cleaning operation by the cleaning system in dependence on a determination of the agricultural machine entering a non-working region of the working environment. Advantageously, the cleaning operation may be initiated during a time where the machine is not working the environment, and as such at a time where the sensing arrangement may not be required. For instance, where the machine comprises a harvester and the sensing arrangement is configured to monitor a grain count and/or quality of harvested material, initiating the cleaning operation when in a non-working region may correspond to a time where there is a reduced or even no material flow through the harvester.

The control system may be configured to determine a control strategy for the cleaning system in dependence on the operational data. The control strategy may comprise an actuation timing for the cleaning system. The control strategy comprises a cycle duration for the cleaning system. The control strategy may comprise a volume of a cleaning fluid released by the cleaning system.

The control system may be configured to control release of a cleaning fluid from the cleaning system. The control system may be configured to control release of a cleaning fluid from the cleaning system onto one or more components of the sensor arrangement in dependence on the operational data. This may include control over a dispensing arrangement (e.g. nozzle or the like) of the cleaning system. The one or more components of the sensor arrangement may include a sensing surface of the sensor arrangement. The sensing surface may comprise a substantially transparent panel positioned between a material flow associated with the agricultural machine and an optical sensor for monitoring one or more properties of the material flow. Such an arrangement may advantageously wet the sensing surface and material build up thereon to aid subsequent removal of such material. In some advantageous embodiments the control system may make use of subsequent impacts by material on the wetted surface and material build up to assist in the removal of the material buildup.

The control system may be configured to receive positional data from a positioning module of, on or otherwise associated with the agricultural machine.

The sensing arrangement may comprise an optical sensor for monitoring one or more properties of a material flow associated with the agricultural machine. For example, in embodiments the sensing arrangement comprises an optical sensor positioned within or proximal to a flow of grain material in a harvester for monitoring one or more properties of the grain material. This may include a measurement of yield and/or grain quality. The optical sensor may be positioned within or proximal to an outlet of a grain conveyor, such as the grain elevator.

A further aspect of the invention provides a cleaning system for a sensor arrangement of an agricultural machine, the cleaning system comprising: a cleaning fluid reservoir; a dispensing arrangement for releasing the cleaning fluid onto a surface of the sensor arrangement; and wherein the cleaning system comprises and/or is controllable under operation of a control system of the preceding aspect(s) of the invention for controlling the release of the cleaning fluid in dependence on operational data indicative of the working of a working environment by the agricultural machine.

The cleaning fluid may comprise water.

A further aspect of the invention provides a sensor arrangement, comprising: an image sensor; a sensor surface; and the cleaning system of the preceding aspect(s) of the invention.

The image sensor may comprise an optical sensor, such as a camera. The sensor surface may comprise a sensor panel positioned between the image sensor and a material flow through the agricultural machine.

A further aspect of the invention provides an agricultural machine comprising a control system, a cleaning system and/or a sensor arrangement of any preceding aspect of the invention.

The agricultural machine may comprise a harvesting machine, such as a combine harvester or forage harvester, for example.

A yet further aspect of the invention provides a method for controlling operation of a cleaning system for a sensor arrangement of an agricultural machine, the method comprising: receiving operational data indicative of a the working of a working environment by the agricultural machine; determining, in dependence on the received operational data, an operation of the agricultural machine within the working environment; and controlling operation of the cleaning system in dependence on the determined operation.

The method may comprise performing one or more operable functions of any component of the control system or system in the manner discussed herein.

A further aspect provides computer software which, when executed by one or more processors, causes performance of a method described herein.

A yet further aspect provides a non-transitory computer readable storage medium comprising computer software described herein.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a schematic view illustrating embodiments of the present disclosure;

FIG. 2 is a schematic view illustrating an embodiment of a control system of the present disclosure;

FIG. 3 is a flowchart illustrating an embodiment of a method;

FIGS. 4A & 4B are images illustrating the operational use of the present disclosure;

FIG. 5 is a schematic view illustrating a further embodiment of a control system; and

FIG. 6 is a schematic view illustrating a third embodiment of a control system.

### DETAILED DESCRIPTION

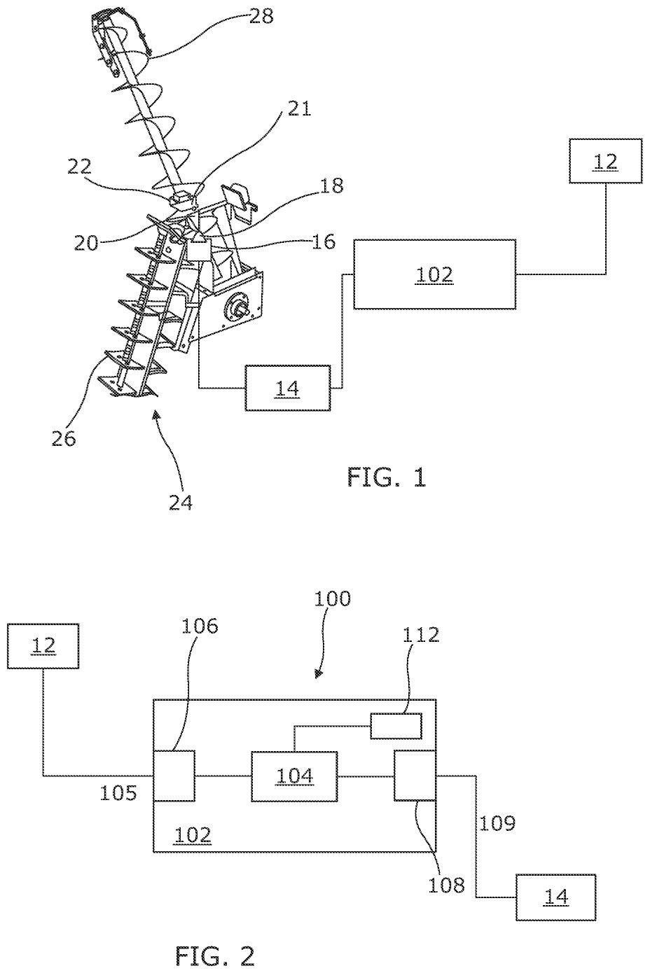

The present disclosure relates, in general, to an agricultural machine in the form of a combine harvester, along with a control system 100 and method 200 for controlling operation of a cleaning system associated with the combine harvester, and specifically a cleaning system for a sensing arrangement of the combine harvester. The present disclosure utilises operational data indicative of the working of a working environment by the agricultural machine to control operation of the cleaning system in the manner discussed herein. In particular, the illustrated embodiments shown in FIGS. 1-4B utilise positional information, determined through analysis of positional data received from a positioning module 12 of the harvester for controlling release of a cleaning fluid from a fluid reservoir 16 of the cleaning system onto a sensor surface 21 of the sensing arrangement for assisting in the removal of dust and other material build up on the sensor surface 21. Further embodiments are discussed herein which utilise other forms of operational data in addition or as an alternative to the positional data for controlling operation of the cleaning system.

### System

FIG. 1 illustrates a system forming part of an agricultural machine in the form of a combine harvester. It will be appreciated that, in use, the combine harvester may comprise or be suitably coupled to a header which is operable in use to cut and gather a strip of crop material as the combine harvester is driven across working environment during a harvesting operation. A conveyor section conveys the cut crop material from the header into a crop processing apparatus which is operable to separate grain and non-grain (i.e. material other than grain (MOG) or residue material (used interchangeably herein)) as will be appreciated. It is noted here that apparatus for separating grain and non-grain material are well-known in the art and the present invention is not limited in this sense. The skilled person will appreciate that numerous different configurations for the crop processing apparatus may be used as appropriate.

Clean grain separated from the cut crop material is collected in a grain bin, which may be periodically emptied, e.g. into a collection vehicle, storage container, etc. utilising an unloading auger 28. The remaining non-grain material (MOG)/residue material is separately moved to a spreader tool which is operable in use to eject the non-grain material or MOG from the rear of the combine harvester and onto the ground. The combine 10 also typically includes, amongst other features, an operator cab, wheels, a power unit and a user interface, for example.

In the illustrated embodiment, the clean grain material is transferred from the crop processing apparatus to the grain bin utilising a grain elevator 24 which comprises multiple paddles 26 configured to collect and raise the grain into the grain bin. A sensing arrangement is provided at an upper end of the grain elevator 24 and incorporates an optical sensor 22 for imaging crop material being transferred by the grain elevator 24. Image data from the optical sensor may be suitably analysed to determine operational parameters associated with the harvesting operation, for example a measure of grain yield or quality. Examples of such analyses are known in the art and are not explained in detail here for brevity as the invention is not limited in this sense. The skilled person will appreciate that such analyses can be made.

A sensor surface 21 is provided between the optical sensor 22 of the sensing arrangement and the material flow within the grain elevator 24. The sensor surface 21 comprises a substantially transparent surface and acts as a shield between the sensing components—the optical sensor 22—and the grain material. It is problems associated with material buildup on surfaces such as this which the present disclosure looks to address.

The illustrated arrangement includes a cleaning system which is controllable under operation of a controller 102 of a control system 100 (discussed hereinbelow) for performance of a cleaning strategy based on a location of the combine harvester within a working environment in the manner discussed herein. As discussed herein, operation of the cleaning system by the controller 102 is performed on the basis of a location of the harvester within the working environment. In order to determine the location of the harvester, a positioning module 12 is provided which provides positional data to the controller 102 indicative of the location of the combine harvester within the working environment. The positioning module 12 forms part of a global and/or local positioning system of the harvester and the invention is not restricted to the specific positioning system of the harvester. For example, the positioning system can comprise any one or more of GPS, GLONASS, Galileo, etc. and/or a local positioning system which incorporates use of a base station located within or proximal to the working environment for locating the harvester locally within the working environment.

The cleaning system incorporates a local control unit 14 operable to control operation of the cleaning system under instruction from the controller 102 in the manner discussed herein. Specifically, control unit 14 can control release of a cleaning fluid from a fluid reservoir 16 via nozzle 18 and onto the sensor surface 21 of the sensing arrangement. Controller 102 advantageously controls the timing and/or duration of this fluid release based on the location of the harvester in the manner discussed herein.

### Control System

The harvester embodies a control system 100 operable to control operation of the cleaning system in the manner discussed herein. Control system 100 is illustrated in FIG. 2.

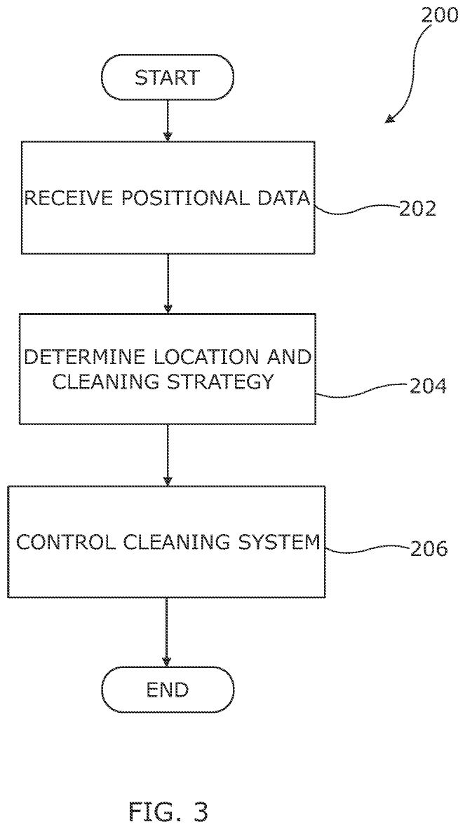

The control system 100 comprises a controller 102 having an electronic processor 104, an electronic input 106, an electronic output 108 and memory 112. The processor 104 is operable to access the memory 112 and execute instructions stored therein to perform given functions, specifically to cause performance of the method 200 of FIG. 3 in the manner described hereinbelow, and ultimately, in the illustrated embodiment, generate and output a control signal(s) 109 from output 108 for controlling operation of the cleaning system (via local control unit 14) based on operational data, here positional data received from a positioning module 12 of the harvester.

The processor 104 is operable to receive input signals from the positioning module 12 where the signals comprise positional data indicative of a location of the harvester within a working environment. The input signals from the positioning module 12 are in the form of input signals 105 received at electronic input 106 of controller 102.

Control signals 109 are output via electronic output 108 to the local control unit 14 of the cleaning system for controlling operation of the cleaning system, e.g. in accordance with a determined cleaning strategy based on the location of the harvester within the working environment. As discussed herein, this can include controlling actuation of the cleaning system based on the location of the harvester relative to working and non-working regions within the environment.

### Method

An embodiment of a method 200 is shown in FIG. 3.

At step 202, positional data is received from the positioning module 12 of the harvester. The positional data includes data indicative of a location of the harvester within a working environment.

At step 204, the positional data is analysed to determine the location of the harvester within the working environment. Specifically, here the determined location of the harvester is used to determine a cleaning strategy for the cleaning system for cleaning the sensor surface 21 of the sensing arrangement. This includes determination of an actuation timing and duration for the release of the cleaning fluid from the fluid reservoir 16 via nozzle 18 onto the sensor surface 21.

In this embodiment, the cleaning strategy is determined in dependence on the location of the agricultural machine with respect to a non-working region of the working environment. More specifically, with respect to a headland region of the working environment. As will be appreciated, when entering a maneuvering in a headland region of a working environment, the harvester would not be working the field—that is would not be harvesting a processing crop material from the field in the manner discussed herein. Accordingly, at such times, the throughput of crop material through the grain elevator 24 and into the grain bin is reduced. In turn, the sensor surface 21 becomes “visible” to the cleaning system due to the reduced level of grain material in the elevator 24. This allows for the cleaning fluid to be released directly onto the sensor surface 21, or at least directly onto material buildup on the sensor surface 21, for the cleaning thereof.

Accordingly, the method comprises determination of a cleaning strategy which includes controlling the release of the cleaning fluid onto the sensor surface 21 whilst the harvester is determined to be within a headland region of the working environment based on the positional data received from the positioning module. This may include release of the cleaning fluid for all or part of the duration of travel in the headland region, or in some instances on determination of the harvester entering the headland region.

At step 206, the cleaning system is controlled in accordance with the determined cleaning strategy. As discussed herein, in practice this comprises the output of control signals from controller 102 to a local control unit 14 of the cleaning system for initiating the cleaning fluid release based on the location of the harvester.

Upon reentry of the harvester into a working region of the environment, and hence an increase in the grain throughput through the grain elevator 24 the control system 100 prevents further release of the cleaning fluid due to the sensor surface 21 becoming once again obscured (from the point of view of the cleaning system) by grain material in the grain elevator 24. However, due to the wetting of the sensor surface 21 and material buildup thereon during performance of the cleaning operation whilst passing through the non-working/headland region, the material build up on the surface is loosened, and further impacts by grain material now passing through the system due to working of the environment and harvesting crop therefrom is advantageously used to dislodge the wetted material build up and in turn clean the sensor surface 21.

In this way, the present disclosure provides a means to utilise conventional operation of the harvester for cleaning the sensor surface, ensuring the sensor surface 21 can be cleaned without incurring downtime of the machine for such purposes. The logic applied to the dispensing of the cleaning fluid also reduces the amount of cleaning fluid that is used as it is only released when necessary and onto the sensor surface (or material buildup on that surface) rather than into crop material obscuring that surface-as would happen were the fluid to be dispensed whilst working the field with little to no cleaning benefit.

### EXAMPLES

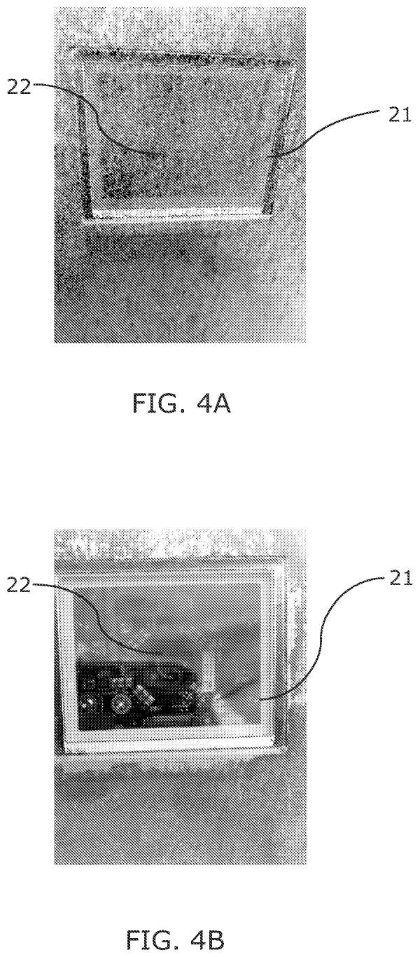

FIGS. 4A and 4B illustrate the operational use of the present invention. Specifically, in FIG. 4A a sensor surface 21 of the sensing arrangement is shown which is obscured by dust and other debris. As the optical sensor 22 is positioned behind this sensor surface 21 its view of the grain material within the grain elevator 24 would be almost entirely restricted to the point where no reliable data from the sensor 22 could be obtained, and hence no measure of the harvester parameters for the grain material could be obtained. FIG. 4B illustrates the same sensor surface 21 following operation of the present disclosure. Due to release of the cleaning fluid onto the sensor surface 21 and subsequent impacts of grain onto the wetted surface, the dust and debris is almost entirely removed from the surface 21 allowing a clear line of sight for the optical sensor 22 and allowing reliable results to be obtained and determined through suitable analysis of the sensor data received therefrom.

### Yield Sensor

FIG. 5 illustrates a first variant of the control system 100 described herein. In this embodiment, operational data is received in the form of yield data from a yield sensor 30 of the harvester. The yield sensor 30 is operable to obtain a measure of an amount of material passing through or within one or more operable components of the harvester. This measure may be indicative of the working of the working environment by the harvester. Where the harvester enters a headland of the working environment, a reduction in this measure is expected, and the control system 100 advantageously utilises this information in the present embodiment for control over the cleaning system. For example, the control system 100 may utilise yield data from the yield sensor 30 to trigger operation of the cleaning system upon detection of a reduction in the flow rate or amount of material present or flowing through the harvester. As discussed herein, this may advantageously ensure the cleaning fluid is deposited onto the sensor surface rather than into crop material.

In all other aspects, the control system 100 of FIG. 5 operates in the same manner as control system 100 shown in FIG. 2 herein.

### Operational Function

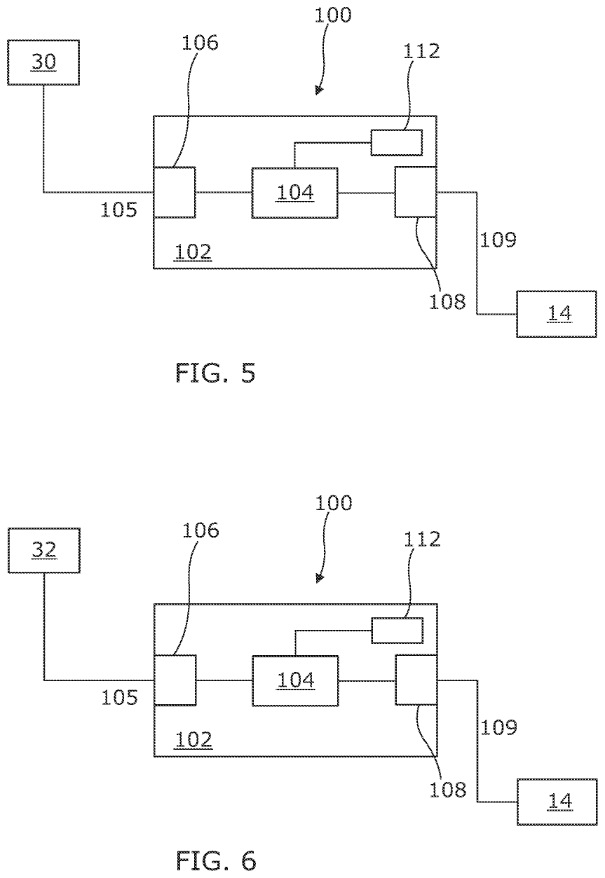

A further variant of control system 100 is shown in FIG. 6. Here, operational data is received from a local control unit 32 associated with a selectable operational function of the harvester. In this embodiment, the local control unit 32 is associated with a user interface in the form of a user terminal located within an operator cab of the harvester. The local control unit may output operational data indicative of the operational state of the operational function, here selection of a headland mode for the harvester, selectable by an operator of the harvester through the user interface. In use, the operator selection of the headland mode may inform the control system 100 that the harvester has entered or is within a headland of the working environment and as such may be suitable for performance of the cleaning strategy by the cleaning system, e.g. for the reasons given herein. The control system 100 may control actuation of the cleaning system in the manner discussed herein upon receipt of the operator selection of the headland mode.

In all other aspects, the control system 100 of FIG. 6 operates in the same manner as control system 100 shown in FIG. 2 herein.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

1. A control system for a sensing arrangement of an agricultural machine, the control system comprising one or more controllers, configured to:
receive operational data indicative of the working of a working environment by the agricultural machine; and
generate and output one or more control signals for controlling operation of a cleaning system associated with a sensor arrangement of the agricultural machine in dependence on the operational data.

2. The control system of claim 1, wherein the operational data comprises positional data indicative of a location of the agricultural machine within the working environment.

3. The control system of claim 2, configured to determine, from the positional data, the location of the agricultural machine within the working environment.

4. The control system of claim 1, wherein the operational data comprises yield data from a yield sensor, the yield data being indicative of a measure of material within and/or flowing through the agricultural machine.

5. The control system of claim 1, wherein the operational data is indicative of an operational state of a selectable operational function of the agricultural machine, and the control system is configured to control operation of the cleaning system in dependence on the operational state of the selectable operational function.

6. The control system of claim 5, wherein the selectable operational function comprises a headland mode for the agricultural machine.

7. The control system of claim 1, configured to determine, from the operational data, whether the agricultural machine is located within a working region or a non-working region of the working environment.

8. The control system of claim 1, configured to:
determine, from the positional data, the location of the agricultural machine within the working environment;
determine, from the operational data, whether the agricultural machine is located within a working region or a non-working region of the working environment
determine from the positional data, the location of the agricultural machine with respect to the working region and/or the non-working region of the working environment.

9. The control system of claim 7, wherein the non-working region of the working environment comprises a headland region.

10. The control system of claim 8, configured to cause performance of a cleaning operation by the cleaning system in dependence on a determination of the agricultural machine being positioned within a non-working region of the working environment.

11. The control system of claim 8, configured to cause performance of a cleaning operation by the cleaning system in dependence on a determination of the agricultural machine entering a non-working region of the working environment.

12. The control system of claim 1, configured to determine a control strategy for the cleaning system in dependence on the operational data.

13. The control system of claim 12, wherein the control strategy comprises an actuation timing for the cleaning system.

14. The control system of claim 12, wherein the control strategy comprises a cycle duration for the cleaning system.

15. The control system of claim 1, configured to control release of a cleaning fluid from the cleaning system onto one or more components of the sensor arrangement in dependence on the operational data.

16. The control system of claim 15, wherein the one or more components of the sensor arrangement comprises a sensing surface of the sensor arrangement.

17. The control system of claim 16, wherein the sensing surface comprises a substantially transparent panel positioned between a material flow associated with the agricultural machine and an optical sensor for monitoring one or more properties of the material flow.

18. A cleaning system for a sensor arrangement of an agricultural machine, the cleaning system comprising:
a cleaning fluid reservoir;
a dispensing arrangement for releasing the cleaning fluid onto a surface of the sensor arrangement;
and wherein the cleaning system comprises and/or is controllable under operation of a control system of any preceding claim for controlling the release of the cleaning fluid in dependence on operational data indicative of the working of a working environment by the agricultural machine.

19. A sensor arrangement, comprising:
an image sensor;
a sensor surface; and
the cleaning system of claim 18.

20. (canceled)

21. A method for controlling operation of a cleaning system for a sensor arrangement of an agricultural machine, the method comprising:
receiving operational data indicative of the working of a working environment by the agricultural machine;
determining, in dependence on the received operational data, an operation of the agricultural machine within the working environment; and
controlling operation of the cleaning system in dependence on the determined operation.
